(19) United States
(12) Patent Application Publication
(10) Pub. No.: US 2026/0279210 A1
(43) Pub. Date: Sep. 17, 2026

(54) EDUCATIONAL SYSTEM

(71) Applicant: ECSEL LLC, Newton, MA (US)

(72) Inventor: Donna Karen Housman, Brookline, MA (US)

(21) Appl. No.: 19/673,265

(22) Filed: May 11, 2026

Related U.S. Application Data
(63) Continuation of application No. 17/489,161, filed on Sep. 29, 2021, now abandoned.
(60) Provisional application No. 63/085,302, filed on Sep. 30, 2020.

(51) Int. Cl. G09B 1/38; A63F 1/02; A63F 1/04; A63F 3/00; G09F 1/02

(52) U.S. Cl. CPC G09B 1/38; A63F 1/02; A63F 1/04; A63F 3/00261; A63F 3/00574; G09F 1/02; A63F 2001/025; A63F 2001/0408; A63F 2001/0475; A63F 2003/00463; A63F 2003/0063

(57) ABSTRACT

An conflict-resolution board system includes: a first emotion identifier storage area configured for storing a first plurality of emotion state identifiers corresponding to a first plurality of emotional states; a second emotion identifier storage area configured for storing a second plurality of emotion state identifiers corresponding to a second plurality of emotional states; and a conflict indication area configured to allow a first participant to indicate their emotional state by selecting one of the first plurality of emotion state identifiers and allow a second participant to indicate their emotional state by selecting one of the second plurality of emotion state identifiers.

### RELATED APPLICATION(S)

This application is a continuation of U.S. patent application Ser. No. 17/489,161 filed on Sep. 29, 2021, which claims the benefit of U.S. Provisional Application No. 63/085,302, filed on 30 Sep. 2020, the entire contents of which are all incorporated herein by reference.

### TECHNICAL FIELD

This disclosure relates to educational systems and, more particularly, to educational systems that enable young children to identify their emotions.

### BACKGROUND

When children are young, their ability to understand and identify the emotions that they are feeling is often compromised/not fully developed. This may result in feelings of frustration and/or inadequacy, as they are not able to verbalize what they are feeling.

As could be imagined, this may result in the creation and exacerbation of conflicts between such children, as their ability to work through differences in greatly hampered by their inability to identify/verbalize how they are feeling.

### SUMMARY OF DISCLOSURE

### The Make Peace Table

In one implementation, a conflict-resolution board system includes: a first emotion identifier storage area configured for storing a first plurality of emotion state identifiers corresponding to a first plurality of emotional states; a second emotion identifier storage area configured for storing a second plurality of emotion state identifiers corresponding to a second plurality of emotional states; and a conflict indication area configured to allow a first participant to indicate their emotional state by selecting one of the first plurality of emotion state identifiers and allow a second participant to indicate their emotional state by selecting one of the second plurality of emotion state identifiers.

One or more of the following features may be included. The conflict indication area may be further configured to allow a third participant to indicate their emotional state by selecting one of the first plurality of emotion state identifiers. The conflict indication area may be further configured to allow a fourth participant to indicate their emotional state by selecting one of the second plurality of emotion state identifiers. The conflict indication area may be further configured to allow the first participant to indicate an additional emotional state by selecting an additional emotion state identifier from the first plurality of emotion state identifiers. The conflict indication area may be further configured to allow the second participant to indicate an additional emotional state by selecting an additional emotion state identifier from the second plurality of emotion state identifiers. The first plurality of emotion state identifiers corresponding to a first plurality of emotional states may include: a first plurality of emotional state definition cards corresponding to the first plurality of emotional states. The first plurality of emotional state definition cards corresponding to the first plurality of emotional states may be magnetic and configured to be releasably attachable to the first emotion identifier storage area and/or the conflict indication area. The first plurality of emotional state definition cards may include: a first plurality of double-sided emotional state definition cards. A first side of each of the first plurality of double-sided emotional state definition cards may correspond to a first gender. A second side of each of the first plurality of double-sided emotional state definition cards may correspond to a second gender. The first plurality of emotional state definition cards corresponding to the first plurality of emotional states may include: at least one common character configured to visually define the first plurality of emotional states. The at least one common character may include: a facial character portion configured to illustrate a facial component of the first plurality of emotional states; and a body character portion configured to illustrate a body component of the first plurality of emotional states. The second plurality of emotion state identifiers corresponding to a second plurality of emotional states may include: a second plurality of emotional state definition cards corresponding to the second plurality of emotional states. The second plurality of emotional state definition cards corresponding to the second plurality of emotional states may be magnetic and configured to be releasably attachable to the second emotion identifier storage area and/or the conflict indication area. The second plurality of emotional state definition cards may include: a second plurality of double-sided emotional state definition cards. A first side of each of the second plurality of double-sided emotional state definition cards may correspond to a first gender. A second side of each of the second plurality of double-sided emotional state definition cards may correspond to a second gender. The second plurality of emotional state definition cards corresponding to the second plurality of emotional states may include: at least one common character configured to visually define the second plurality of emotional states. The at least one common character may include: a facial character portion configured to illustrate a facial component of the second plurality of emotional states; and a body character portion configured to illustrate a body component of the second plurality of emotional states.

In another implementation, a conflict-resolution board system includes: a first emotion identifier storage area configured for storing a first plurality of emotion state identifiers corresponding to a first plurality of emotional states; a second emotion identifier storage area configured for storing a second plurality of emotion state identifiers corresponding to a second plurality of emotional states; and a conflict indication area configured to allow a first participant to indicate their emotional state by selecting one of the first plurality of emotion state identifiers and allow a second participant to indicate their emotional state by selecting one of the second plurality of emotion state identifiers; wherein the conflict indication area is further configured to allow a third participant to indicate their emotional state by selecting one of the first plurality of emotion state identifiers; and wherein the conflict indication area is further configured to allow a fourth participant to indicate their emotional state by selecting one of the second plurality of emotion state identifiers.

One or more of the following features may be included. The first plurality of emotion state identifiers corresponding to a first plurality of emotional states may include: a first plurality of emotional state definition cards corresponding to the first plurality of emotional states. The first plurality of emotional state definition cards corresponding to the first plurality of emotional states may be magnetic and configured to be releasably attachable to the first emotion identifier storage area and/or the conflict indication area. The second plurality of emotion state identifiers corresponding to a second plurality of emotional states may include: a second plurality of emotional state definition cards corresponding to the second plurality of emotional states. The second plurality of emotional state definition cards corresponding to the second plurality of emotional states may be magnetic and configured to be releasably attachable to the second emotion identifier storage area and/or the conflict indication area.

In one implementation, a conflict-resolution board system includes: a first emotion identifier storage area configured for storing a first plurality of emotion state identifiers corresponding to a first plurality of emotional states; a second emotion identifier storage area configured for storing a second plurality of emotion state identifiers corresponding to a second plurality of emotional states; and a conflict indication area configured to allow a first participant to indicate their emotional state by selecting one of the first plurality of emotion state identifiers and allow a second participant to indicate their emotional state by selecting one of the second plurality of emotion state identifiers; wherein the conflict indication area is further configured to allow the first participant to indicate an additional emotional state by selecting an additional emotion state identifier from the first plurality of emotion state identifiers; and wherein the conflict indication area is further configured to allow the second participant to indicate an additional emotional state by selecting an additional emotion state identifier from the second plurality of emotion state identifiers.

One or more of the following features may be included. The first plurality of emotion state identifiers corresponding to a first plurality of emotional states may include: a first plurality of emotional state definition cards corresponding to the first plurality of emotional states. The first plurality of emotional state definition cards corresponding to the first plurality of emotional states may be magnetic and configured to be releasably attachable to the first emotion identifier storage area and/or the conflict indication area. The second plurality of emotion state identifiers corresponding to a second plurality of emotional states may include: a second plurality of emotional state definition cards corresponding to the second plurality of emotional states. The conflict-resolution board system of claim 26 wherein the second plurality of emotional state definition cards corresponding to the second plurality of emotional states are magnetic and configured to be releasably attachable to the second emotion identifier storage area and/or the conflict indication area.

The details of one or more implementations are set forth in the accompanying drawings and the description below. Other features and advantages will become apparent from the description, the drawings, and the claims.

### BRIEF DESCRIPTION OF THE DRAWINGS

FIGS. 1-2 are diagrammatic views of an emotional learning system according to an embodiment of the present disclosure;

FIG. 3 is a diagrammatic view of a plurality of emotional states according to an embodiment of the present disclosure;

FIG. 4 is a diagrammatic view of an emotion-indication board system according to an embodiment of the present disclosure; and

FIG. 5 is a diagrammatic view of a conflict-resolution board system according to an embodiment of the present disclosure.

Like reference symbols in the various drawings indicate like elements.

### DETAILED DESCRIPTION OF THE PREFERRED EMBODIMENTS

Described below in greater detail is a system (and various components thereof) that enable a younger child to identify and understand the emotion(s) that they are feeling and express the same to others.

### The Emotion Cards

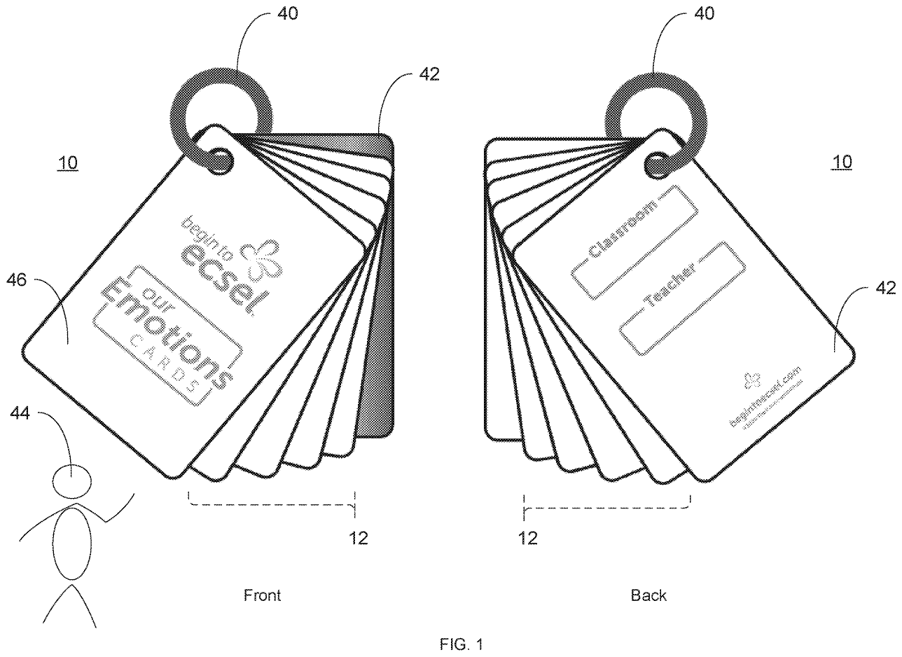

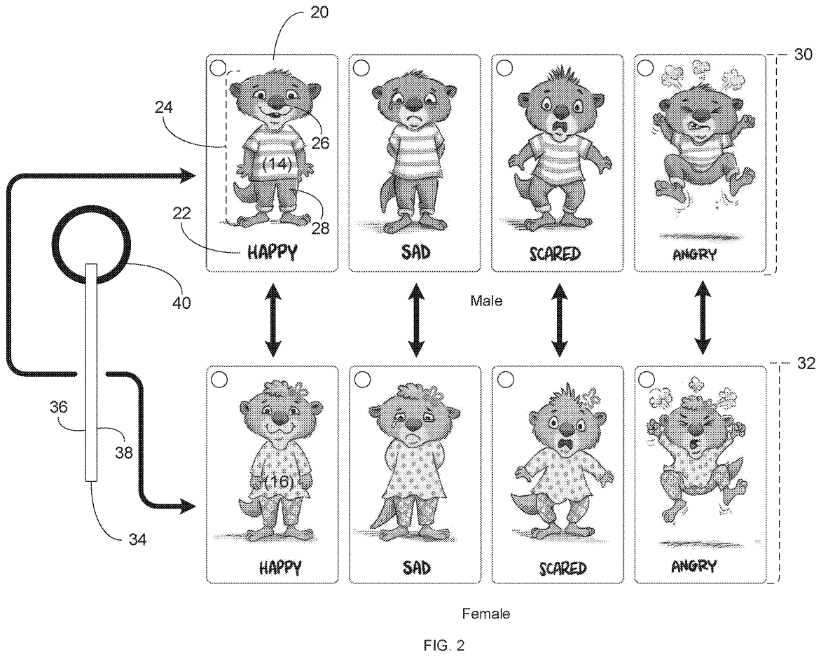

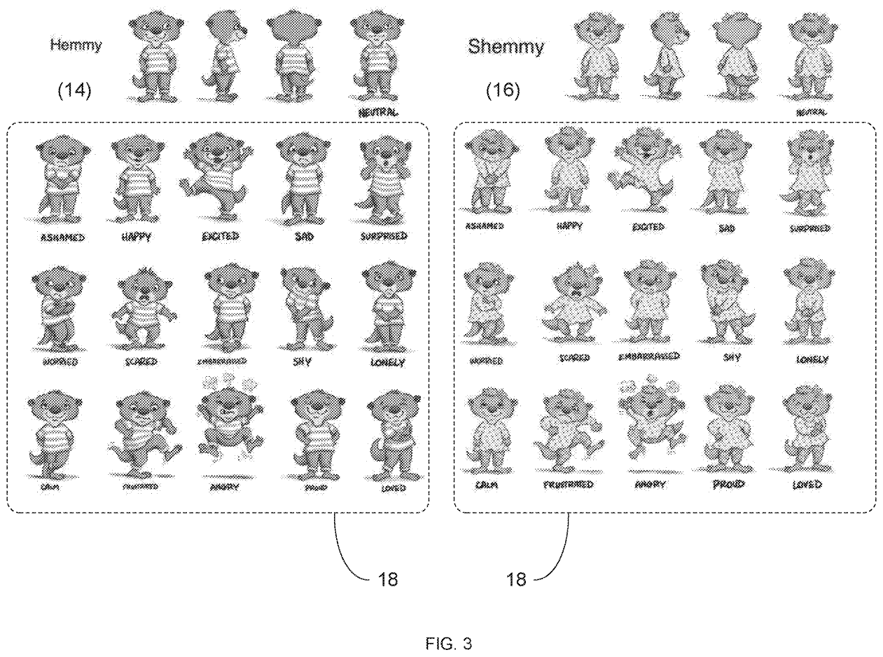

Referring to FIGS. 1-3, there is shown emotional learning system 10. Emotional learning system 10 may include a plurality of emotion state identifiers (e.g., plurality of emotion state identifiers 12) that includes at least one common character (e.g., common characters 14, 16) configured to visually define a plurality of emotional states (e.g., emotional states 18). While in this particular example, emotional states 18 is shown to include fifteen emotional states (namely ashamed, happy, excited, sad, surprised, worried, scared, embarrassed, shy, lonely, clam, frustrated, angry, proud and loved), this is for illustrative purposes only and is not intended to be a limitation of this disclosure, as other configurations are possible and are consider to be within the scope of this disclosure.

The plurality of emotion state identifiers (e.g., plurality of emotion state identifiers 12) may be configured to visually and textually define the plurality of emotional states (e.g., emotional states 18). For example, emotion state identifier 20 may include text 22 to textually define the emotional state “Happy” and image 24 to visually define the emotional state “Happy”.

The at least one common character (e.g., common characters 14, 16) may include a facial character portion (e.g., facial character portion 26) configured to illustrate a facial component of the plurality of emotional states (e.g., emotional states 18). Accordingly and in this example, facial character portion 26 of common character 14 is shown to illustrate the emotional state “Happy”, wherein the eyes are wide, the mouth is smiling and the ears are upright.

Further, the at least one common character (e.g., common characters 14, 16) may include a body character portion (e.g., body character portion 28) configured to illustrate a body component of the plurality of emotional states (e.g., emotional states 18). Accordingly and in this example, body character portion 28 of common character 14 is shown to illustrate the emotional state “Happy”, wherein the shoulders are back and the arms are relaxed.

Additionally, the at least one common character (e.g., common characters 14, 16) may include: a first common character (e.g., first common character 14) and a second common character (e.g., second common character 16), wherein the first common character (e.g., first common character 14) may correspond to a first gender (e.g., male in this example) and the second common character (e.g., second common character 16) may correspond to a second gender (e.g., female in this example).

An example of the plurality of emotion state identifiers (e.g., plurality of emotion state identifiers 12) may include a plurality of emotional state definition cards (e.g., emotional state definition cards 30, 32) corresponding to the plurality of emotional states (e.g., emotional states 18). Specifically and in this example, male-gendered emotional state definition cards 30 may illustrate male common character 14 and may correspond to the fifteen emotional states (e.g., emotional states 18), namely ashamed, happy, excited, sad, surprised, worried, scared, embarrassed, shy, lonely, clam, frustrated, angry, proud and loved. Additionally and in this example, female-gendered emotional state definition cards 32 may illustrate female common character 16 and may correspond to the fifteen emotional states (e.g., emotional states 18), namely ashamed, happy, excited, sad, surprised, worried, scared, embarrassed, shy, lonely, clam, frustrated, angry, proud and loved.

An example of the plurality of emotional state definition cards (e.g., emotional state definition cards 30, 32) may include but is not limited to a plurality of double-sided emotional state definition cards (e.g., double-sided emotional state definition card 34). When configured in such a double-sided manner, a first side (e.g., first side 36) of each of the plurality of double-sided emotional state definition cards (e.g., double-sided emotional state definition card 34) may correspond to a first gender (e.g., male in this example) and a second side (e.g., second side 38) of each of the plurality of double-sided emotional state definition cards (e.g., double-sided emotional state definition card 34) may correspond to a second gender (e.g., female in this example).

Therefore and through the use of fifteen double-sided emotional state definition cards (e.g., double-sided emotional state definition card 34), each of the fifteen emotional states (namely ashamed, happy, excited, sad, surprised, worried, scared, embarrassed, shy, lonely, clam, frustrated, angry, proud and loved) may be defined on a single double-sided emotional state definition cards (e.g., double-sided emotional state definition card 34), wherein one side (e.g., first side 36) of the double-sided emotional state definition card (e.g., double-sided emotional state definition card 34) illustrates a first gender (e.g., male in this example) experiencing that emotion and the other side (e.g., second side 38) of the double-sided emotional state definition card (e.g., double-sided emotional state definition card 34) illustrates a second gender (e.g., female in this example) experiencing that emotion.

The plurality of emotional state definition cards (e.g., emotional state definition cards 30, 32) may be coupled together via a coupling device (e.g., coupling device 40), wherein an example of such a coupling device (e.g., coupling device 40) may include but is not limited to a ring assembly. Through the use of coupling device 40, emotional state definition cards 30, 32 (e.g., fifteen emotional state definition cards if double-sided or thirty emotional state definition cards if single-sided) may be easily organized and stored. Additionally, coupling device 40 (e.g., through the use of an opening ring assembly) may be configured to allow emotional state definition cards 30, 32 to be stored and/or used as a group or separated for use.

Emotional learning system 10 may include a self-emotion defining device (e.g., self-emotion defining device 42) configured to allow a user (e.g., user 44) to identify their own emotional state so that it may be compared to the plurality of emotional states (e.g., emotional states 18). An example of the self-emotion defining device (e.g., self-emotion defining device 42) may be a visual self-emotion defining device, an example of which may include but is not limited to a reflective device (such as a mirror) configured to enable the user (e.g., user 44) to see their reflection.

For example, assume that user 44 (e.g., a young child) is feeling an emotion (e.g., at home, at daycare, at kindergarten, at pre-k) that (due to their youth) they do not understand and cannot identify. Accordingly, the user (e.g., user 44) may utilize self-emotion defining device 42 to view their face/body to see what they look like. The user (e.g., user 44) may then review the emotional state definition cards 30, 32 (the female-gender cards if they are female and the male-gender cards if they are male) to identify a visual match. When a visual match is identified, the matching emotional state definition card may indicate (e.g., textually) the emotional state of the user (e.g., user 44).

Emotional learning system 10 may include a cover assembly (e.g., cover assembly 46) configured to protect plurality of emotion state identifiers 12 (e.g., emotional state definition cards 30, 32).

### The Emotion Chart

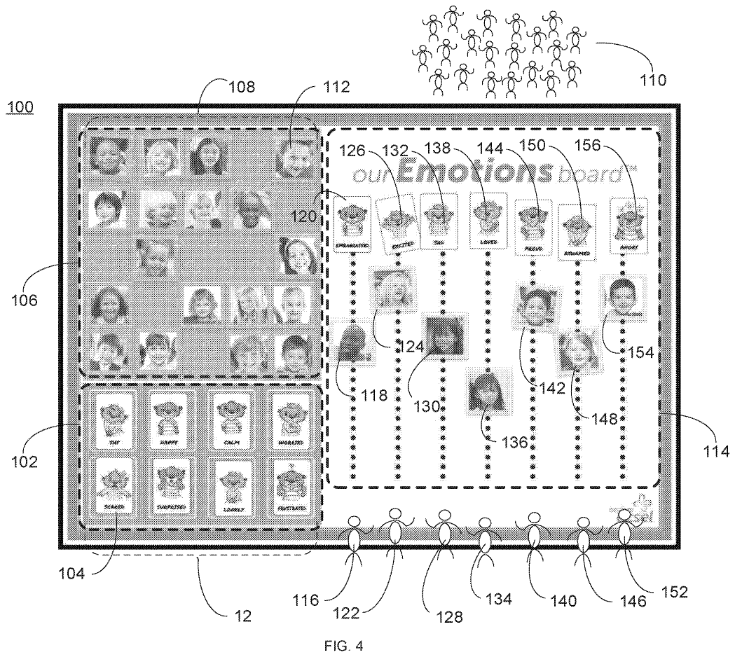

Referring to FIG. 4, there is shown emotion-indication board system 100 that may be configured to work with plurality of emotion state identifiers 12 (e.g., emotional state definition cards 30, 32), or some variant thereof.

Emotion-indication board system 100 may include an emotion identifier storage area (e.g., emotion identifier storage area 102) configured for storing a plurality of emotion state identifiers (e.g., plurality of emotion state identifiers 12) corresponding to a plurality of emotional states (e.g., emotional states 18). When configured to work with emotion-indication board system 100, the plurality of emotion state identifiers (e.g., plurality of emotion state identifiers 12) may be identical to or different from the above-described (e.g., ring-bound) emotion state identifiers. For example, the emotion state identifiers that are configured to work with emotion-indication board system 100 may be smaller in size than the above-described (e.g., ring-bound) emotion state identifiers.

As discussed above, the plurality of emotion state identifiers (e.g., plurality of emotion state identifiers 12) corresponding to a plurality of emotional states (e.g., emotional states 18) may include a plurality of emotional state definition cards (e.g., emotional state definition card 104) corresponding to the plurality of emotional states (e.g., emotional states 18) namely ashamed, happy, excited, sad, surprised, worried, scared, embarrassed, shy, lonely, clam, frustrated, angry, proud and loved.

As also discussed above, the plurality of emotional state definition cards (e.g., emotional state definition card 104) may include a plurality of double-sided emotional state definition cards (e.g., double-sided emotional state definition card 34), wherein a first side (e.g., first side 36) of each of the plurality of double-sided emotional state definition cards (e.g., double-sided emotional state definition card 34) corresponds to a first gender (e.g., male in this example) and a second side (e.g., second side 38) of each of the plurality of double-sided emotional state definition cards (e.g., double-sided emotional state definition card 34) corresponds to a second gender (e.g., female in this example).

Emotion-indication board system 100 may include a participant identifier storage area (e.g., participant identifier storage area 106) configured for storing a plurality of participant identifiers (e.g., plurality of participant identifiers 108) corresponding to a plurality of participants (e.g., plurality of children 110). The plurality of participant identifiers (e.g., plurality of participant identifiers 108) corresponding to the plurality of participants (e.g., plurality of children 110) may include: a plurality of participant identifier cards (e.g., participant identifier card 112) corresponding to the plurality of participants (e.g., plurality of children 110).

Further, emotion-indication board system 100 may include an emotion indication area (e.g., emotion indication area 114) configured to allow one or more of the plurality of participants (e.g., plurality of children 110) to indicate their emotional state via one or more of the plurality of participant identifiers (e.g., plurality of participant identifiers 108) and one or more of the plurality of emotional state identifiers (e.g., plurality of emotion state identifiers 12).

The plurality of emotional state definition cards (e.g., emotional state definition card 104) corresponding to the plurality of emotional states (e.g., emotional states 18) may be magnetic and configured to be releasably attachable to the emotion identifier storage area (e.g., emotion identifier storage area 102) and/or the emotion indication area (e.g., emotion indication area 114). Accordingly and when not being used, the emotional state definition cards (e.g., emotional state definition card 104) may be magnetically-affixed within emotion identifier storage area 102. Alternatively and when in use, the emotional state definition cards (e.g., emotional state definition card 104) may be magnetically-affixed within emotion indication area 114.

The plurality of participant identifiers (e.g., plurality of participant identifiers 108) corresponding to the plurality of participants (e.g., plurality of children 110) may be magnetic and configured to be releasably attachable to the participant identifier storage area (e.g., participant identifier storage area 106) and/or the emotion indication area (e.g., emotion indication area 114). Accordingly and when not being used, the participant identifier cards (e.g., participant identifier card 112) may be magnetically-affixed within participant identifier storage area 106. Alternatively and when in use, the participant identifier cards (e.g., participant identifier card 112) may be magnetically-affixed within emotion indication area 114.

Accordingly, assume that plurality of children 110 wish to indicate the emotion that they are each feeling to their colleagues. Therefore:
If user 116 is feeling embarrassed, user 116 may select their participant identifier card (e.g., participant identifier card 118) from plurality of participant identifiers 108 and may select “embarrassed” emotional state definition card 120 (in the appropriate gender) from plurality of emotion state identifiers 12 and affix both of them within emotion indication area 114, thus indicating that user 116 is feeling embarrassed;
If user 122 is feeling excited, user 122 may select their participant identifier card (e.g., participant identifier card 124) from plurality of participant identifiers 108 and may select “excited” emotional state definition card 126 (in the appropriate gender) from plurality of emotion state identifiers 12 and affix both of them within emotion indication area 114, thus indicating that user 122 is feeling excited;
If user 128 is feeling sad, user 128 may select their participant identifier card (e.g., participant identifier card 130) from plurality of participant identifiers 108 and may select “sad” emotional state definition card 132 (in the appropriate gender) from plurality of emotion state identifiers 12 and affix both of them within emotion indication area 114, thus indicating that user 128 is feeling sad;
If user 134 is feeling loved, user 134 may select their participant identifier card (e.g., participant identifier card 136) from plurality of participant identifiers 108 and may select “loved” emotional state definition card 138 (in the appropriate gender) from plurality of emotion state identifiers 12 and affix both of them within emotion indication area 114, thus indicating that user 134 is feeling loved;
If user 140 is feeling proud, user 140 may select their participant identifier card (e.g., participant identifier card 142) from plurality of participant identifiers 108 and may select “proud” emotional state definition card 144 (in the appropriate gender) from plurality of emotion state identifiers 12 and affix both of them within emotion indication area 114, thus indicating that user 140 is feeling proud;
If user 146 is feeling ashamed, user 146 may select their participant identifier card (e.g., participant identifier card 148) from plurality of participant identifiers 108 and may select “ashamed” emotional state definition card 150 (in the appropriate gender) from plurality of emotion state identifiers 12 and affix both of them within emotion indication area 114, thus indicating that user 146 is feeling ashamed; and
If user 152 is feeling angry, user 152 may select their participant identifier card (e.g., participant identifier card 154) from plurality of participant identifiers 108 and may select “angry” emotional state definition card 156 (in the appropriate gender) from plurality of emotion state identifiers 12 and affix both of them within emotion indication area 114, thus indicating that user 152 is feeling angry.

### The Make Peace Table

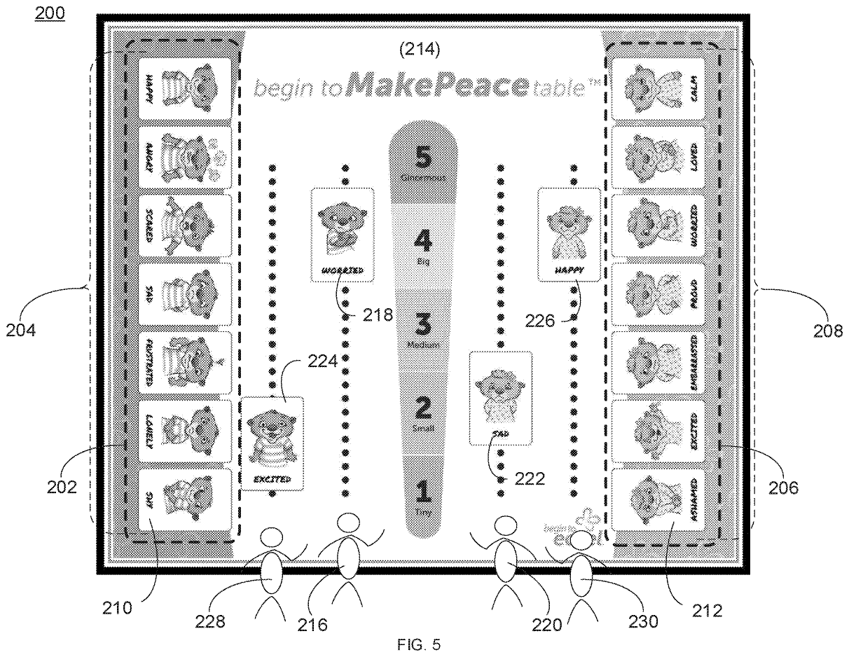

Referring to FIG. 5, there is shown a conflict-resolution board system 200 that may be configured to work with plurality of emotion state identifiers 12 (e.g., emotional state definition cards 30, 32), or some variant thereof. When configured to work with conflict-resolution board system 200, the plurality of emotion state identifiers (e.g., plurality of emotion state identifiers 12) may be identical to or different from the above-described (e.g., ring-bound) emotion state identifiers. For example, the emotion state identifiers that are configured to work with conflict-resolution board system 200 may be smaller in size than the above-described (e.g., ring-bound) emotion state identifiers.

Conflict-resolution board system 200 may include:
a first emotion identifier storage area (e.g., first emotion identifier storage area 202) configured for storing a first plurality of emotion state identifiers (e.g., first plurality of emotion state identifiers 204) corresponding to a first plurality of emotional states (e.g., emotional states 18); and
a second emotion identifier storage area (e.g., second emotion identifier storage area 206) configured for storing a second plurality of emotion state identifiers (e.g., second plurality of emotion state identifiers 208) corresponding to a second plurality of emotional states (e.g., emotional states 18).

As discussed above, the emotion state identifiers (e.g., first plurality of emotion state identifiers 204 and/or second plurality of emotion state identifiers 208) corresponding to a plurality of emotional states (e.g., emotional states 18) may include a plurality of emotional state definition cards (e.g., emotional state definition card 210 and/or emotional state definition card 212) corresponding to the plurality of emotional states (e.g., emotional states 18) namely ashamed, happy, excited, sad, surprised, worried, scared, embarrassed, shy, lonely, clam, frustrated, angry, proud and loved.

As also discussed above, the plurality of emotional state definition cards (e.g., emotional state definition card 210 and/or emotional state definition card 212) may include a plurality of double-sided emotional state definition cards (e.g., double-sided emotional state definition card 34), wherein a first side (e.g., first side 36) of each of the plurality of double-sided emotional state definition cards (e.g., double-sided emotional state definition card 34) corresponds to a first gender (e.g., male in this example) and a second side (e.g., second side 38) of each of the plurality of double-sided emotional state definition cards (e.g., double-sided emotional state definition card 34) corresponds to a second gender (e.g., female in this example).

Conflict-resolution board system 200 may include a conflict indication area (e.g., conflict indication area 214) configured to allow a first participant (e.g., first participant 216) to indicate their emotional state (e.g., emotional state 218) by selecting one of the first plurality of emotion state identifiers (e.g., first plurality of emotion state identifiers 204) and allow a second participant (e.g., second participant 220) to indicate their emotional state (e.g., emotional state 222) by selecting one of the second plurality of emotion state identifiers (e.g., second plurality of emotion state identifiers 208).

Accordingly, assume that first participant 216 and second participant 220 are arguing and feeling emotions that they would like to express, wherein first participant 216 is feeling worried and second participant 220 is feeling sad. Accordingly, first participant 216 may indicate that they are feeling worried by selecting “worried” from first plurality of emotion state identifiers 204 and placing the selected “worried” emotion state identifier that within conflict indication area 214 to indicate their emotional state (e.g., emotional state 218) as “worried”. Additionally, second participant 220 may indicate that they are feeling sad by selecting “sad” from second plurality of emotion state identifiers 208 and placing the selected “sad” emotion state identifier that within conflict indication area 214 to indicate their emotional state (e.g., emotional state 222) as “sad”. Additionally, the strength of this emotion being felt (e.g., worried with respect to first participant 216 and sad with respect to second participant 220) may be indicated by moving emotional state 218 and/or emotional state 222 upward (to indicate a higher intensity level of the emotion) or downward (to indicate a lower intensity level of emotion).

The conflict indication area (e.g., conflict indication area 214) may be further configured to allow the first participant (e.g., first participant 216) to indicate an additional emotional state (e.g., emotional state 224) by selecting an additional emotion state identifier from the first plurality of emotion state identifiers (e.g., first plurality of emotion state identifiers 204). Additionally, the conflict indication area (e.g., conflict indication area 214) may be further configured to allow the second participant (e.g., second participant 220) to indicate an additional emotional state (e.g., emotional state 226) by selecting an additional emotion state identifier from the second plurality of emotion state identifiers (e.g., second plurality of emotion state identifiers 208).

Accordingly, assume that first participant 216 is also feeling excited and second participant 220 is also feeling happy. Accordingly, first participant 216 may indicate that they are feeling excited by selecting “excited” from first plurality of emotion state identifiers 204 and placing the selected “excited” emotion state identifier within conflict indication area 214 to indicate their additional emotional state (e.g., emotional state 224) as “excited”. Additionally, second participant 220 may indicate that they are feeling happy by selecting “happy” from second plurality of emotion state identifiers 208 and placing the selected “happy” emotion state identifier within conflict indication area 214 to indicate their emotional state (e.g., emotional state 226) as “happy”. As above, the strength of this emotion being felt (e.g., excited with respect to first participant 216 and happy with respect to second participant 220) may be indicated by moving emotional state 224 and/or emotional state 226 upward (to indicate a higher intensity level of the emotion) or downward (to indicate a lower intensity level of emotion).

Additionally/alternatively, the conflict indication area (e.g., conflict indication area 214 may be configured to allow more than two people to simultaneously express their emotion. For example, the conflict indication area (e.g., conflict indication area 214) may be further configured to allow a third participant (e.g., third participant 228) to indicate their emotional state (e.g., emotional state 224) by selecting one of the first plurality of emotion state identifiers (e.g., first plurality of emotion state identifiers 204) and/or may be configured to allow a fourth participant (e.g., fourth participant 230) to indicate their emotional state (e.g., emotional state 226) by selecting one of the second plurality of emotion state identifiers (e.g., second plurality of emotion state identifiers 208). As above, the strength of this emotion being felt (e.g., excited with respect to third participant 228 and happy with respect to fourth participant 230) may be indicated by moving emotional state 224 and/or emotional state 226 upward (to indicate a higher intensity level of the emotion) or downward (to indicate a lower intensity level of emotion).

In a fashion similar to that described above, the first plurality of emotional state definition cards (e.g., emotional state definition card 210) corresponding to the first plurality of emotional states (e.g., emotional states 218) may be magnetic and configured to be releasably attachable to the first emotion identifier storage area (e.g., first emotion identifier storage area 202) and/or the conflict indication area (e.g., conflict indication area 214).

In a fashion similar to that described above, the second plurality of emotional state definition cards (e.g., emotional state definition card 212) corresponding to the second plurality of emotional states (e.g., emotional states 218) may be magnetic and configured to be releasably attachable to the second emotion identifier storage area (e.g., first emotion identifier storage area 206) and/or the conflict indication area (e.g., conflict indication area 214).

### General

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A conflict resolution method comprising:
identifying, by a first participant, an emotional state of the first participant;
selecting, by the first participant an emotion state identifier corresponding to the emotional state of the first participant from a first plurality of emotion state identifiers from a first emotion state identifier storage area of a conflict resolution board;
displaying, by the first participant, the emotion state identifier corresponding to the emotional state of the first participant on the conflict resolution board;
identifying, by a second participant, an emotional state of the second participant;
selecting, by the second participant, a second emotion state identifier corresponding to the emotional state of the second participant from a second plurality of emotion state identifiers from a second emotion state identifier storage area of the conflict resolution board; and
displaying, by the second participant, the emotion state identifier corresponding to the emotional state of the second participant on the conflict resolution board.

2. The method according to claim 1, further comprising:
identifying, by one or more additional participants, and emotional state of the one or more additional participants;
selecting, by the one or more additional participants, an emotion state identifier corresponding to the emotional state of the one or more additional participants from an emotion state identifier storage area of the conflict resolution board, wherein the emotion state identifier storage area includes one or more of: the first emotion state identifier storage area of the conflict resolution board, the second emotion state identifier storage area of the conflict resolution board, and an additional emotion state identifier storage area of the conflict resolution board.

3. The method according to claim 1, further comprising:
identifying, by the first participant an additional emotional state of the first participant;
selecting, by the first participant, an additional emotion state identifier corresponding to the additional emotional state of the first participant from the first emotion state identifier storage area of the conflict resolution board; and
displaying, by the first participant, the additional emotion state identifier corresponding to the additional emotional state of the first participant on the conflict resolution board.

4. The method according to claim 1, further comprising:
identifying, by the second participant an additional emotional state of the second participant;
selecting, by the second participant, an additional emotion state identifier corresponding to the additional emotional state of the second participant from the second emotion state identifier storage area of the conflict resolution board; and
displaying, by the second participant, the additional emotion state identifier corresponding to the additional emotional state of the second participant on the conflict resolution board.

5. The method according to claim 1, wherein the first plurality of emotion state identifiers include a first plurality of emotional state definition cards corresponding to a first plurality of emotional states.

6. The method according to claim 5, wherein the first plurality of emotional state definition cards corresponding to the first plurality of emotional states are magnetic and configured to be releasably attachable to the conflict resolution board.

7. The method according to claim 6, wherein:
displaying, by the first participant, the emotion state identifier corresponding to the emotional state of the first participant on the conflict resolution board includes magnetically adhering the emotion state identifier corresponding to the emotional state of the first participant to the conflict resolution board.

8. The method according to claim 5, wherein the first plurality of emotional state definition cards includes:
a first plurality of double-sided emotional state definition cards.

9. The method according to claim 8, wherein:
a first side of each of the first plurality of double-sided emotional state definition cards corresponds to a first gender; and
a second side of each of the first plurality of double-sided emotional state definition cards corresponds to a second gender.

10. The method according to claim 5, wherein the first plurality of emotional state definition cards corresponding to the first plurality of emotional states include:
at least one common character configured to visually define the first plurality of emotional states.

11. The method according to claim 10, wherein the at least one common character includes:
a facial character portion configured to illustrate a facial component of the first plurality of emotional states; and
a body character portion configured to illustrate a body component of the first plurality of emotional states.

12. The method according to claim 1, wherein the second plurality of emotion state identifiers include a second plurality of emotional state definition cards corresponding to a second plurality of emotional states.

13. The method according to claim 12, wherein the second plurality of emotional state definition cards corresponding to the second plurality of emotional states are magnetic and configured to be releasably attachable to the conflict resolution board.

14. The method according to claim 13, wherein:
displaying, by the second participant, the emotion state identifier corresponding to the emotional state of the second participant on the conflict resolution board includes magnetically adhering the emotion state identifier corresponding to the emotional state of the second participant to the conflict resolution board.

15. The method according to claim 12, wherein the second plurality of emotional state definition cards includes:
a second plurality of double-sided emotional state definition cards.

16. The method according to claim 15, wherein:
a first side of each of the second plurality of double-sided emotional state definition cards corresponds to a first gender; and
a second side of each of the second plurality of double-sided emotional state definition cards corresponds to a second gender.

17. The method according to claim 12, wherein the second plurality of emotional state definition cards corresponding to the second plurality of emotional states include:
at least one common character configured to visually define the second plurality of emotional states.

18. The method according to claim 17, wherein the at least one common character includes:
a facial character portion configured to illustrate a facial component of the second plurality of emotional states; and
a body character portion configured to illustrate a body component of the second plurality of emotional states.
